(19) United States
(12) Patent Application Publication
(10) Pub. No.: US 2018/0286219 A1
(43) Pub. Date: Oct. 4, 2018

(54) Customer Link

(71) Applicant: Continental Automotive Systems, Inc., Auburn Hills, MI (US)

(72) Inventors: Zachary Joseph Bolton, Birmingham, MI (US); Jason Brian Schwegler, Grand Blanc, MI (US); Mehmed Muharemovic, Harrison Township, MI (US)

(21) Appl. No.: 15/472,771

(22) Filed: Mar. 29, 2017

(51) Int. Cl. G08C 17/02; H04W 76/02; H04W 4/00; G08G 1/00; H04L 12/40; G06Q 30/02

(52) U.S. Cl. CPC G08C 17/02; H04W 76/025; H04W 4/008; H04W 84/12; H04L 12/40; G06Q 30/0281; G08G 1/205

(57) ABSTRACT

A taxi or other vehicle summoned by someone who needs a ride can be remotely controlled to announce its presence by the person who summoned the taxi or other vehicle. Using a cell phone, a user establishes a wireless communications link between his or her cell phone and a cell phone in the taxi or other vehicle. A second wireless link between the taxi-located cell phone and the vehicle's control bus enables commands to be sent to the vehicle's horn, lights and other annunciators from the user's cell phone. Images of the requesting user can also be sent to the taxi-located cell phone.

### BACKGROUND

Some taxi services provide rides to individuals who arrange a ride by or through an “app” on a cell phone or through a website. When a user requests such a taxi, the user's location, i.e., where the user wants to be picked up from, is provided to the taxi service along with the destination that the user wants to get to. When a ride is “arranged” by the service provider, the license plate and description of the vehicle that will pick up the user is provided to the user's cell phone or web browser so that the user doesn't get into the wrong vehicle.

When a taxi summoned by a user arrives at the user's pick up location, the vehicle's license plate is not always visible from where the user might be located when the vehicle actually arrives. And, the taxi driver rarely knows what his or her passenger looks like. A method and apparatus that would facilitate identifying a hired vehicle to a user when it arrives at a user's location, and for identifying a paying passenger to a driver, would be an improvement over the prior art.

### BRIEF DESCRIPTION OF THE FIGURES

FIG. 1 is a block diagram of a system for controlling a motor vehicle annunciator from a cell phone, which is located away from and outside of the motor vehicle;

FIG. 2 is a block diagram of a motor vehicle, and various annunciators which can be remotely controlled;

FIG. 3 is a block diagram of a motor vehicle C.A.N. bus and various peripheral devices connected to it and by which an annunciator can be actuated;

FIG. 4 depicts steps of a method for controlling a motor vehicle annunciator from a remote cell phone; and

FIG. 5 depicts a processor and associated non-transitory memory coupled to a vehicle C.A.N. bus and configured to control a motor vehicle's annunciator.

### DETAILED DESCRIPTION

As used herein, the term “annunciator” refers to a device that announces a motor vehicle. Headlights, parking lights, turn signal indicators, a vehicle's horn, its audio system and the position or operation of a vehicle's windows are examples of vehicle annunciators because the state or operation of them is perceptible by a person and can be used to identify or distinguish one vehicle from others.

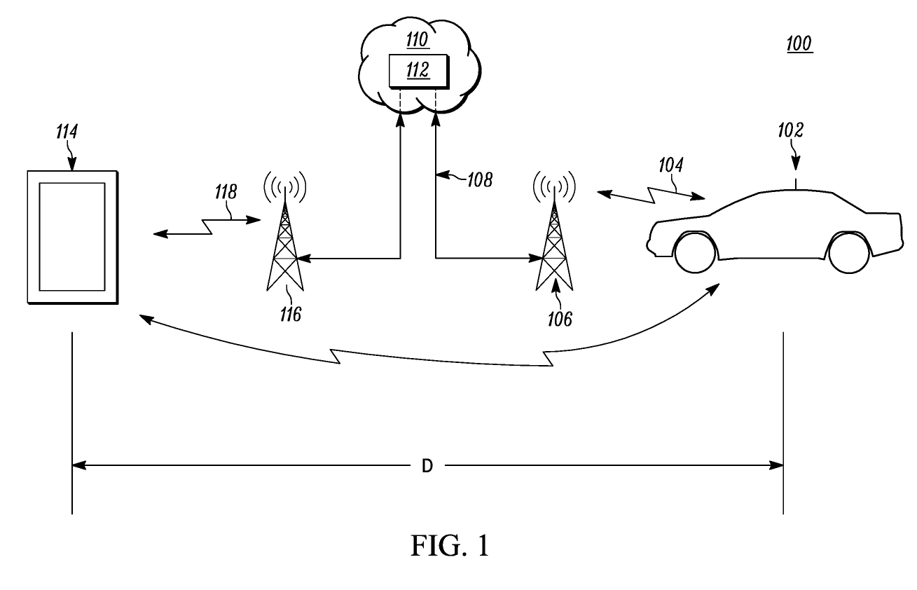

FIG. 1 is a block diagram of a system 100 for controlling a motor vehicle annunciator from a remote location. And, as used herein, the term “remote location” refers to a distance, D, less than about 200-300 hundred feet.

In the system 100, a motor vehicle 102 includes a cellular telephone having WI-FI connectivity capability inside the vehicle and not visible in FIG. 1. The vehicle-located cell phone communicates wirelessly 104 with a nearby cell tower 106 using methods and apparatus well known in the art. As described below, the same cell phone communicates wirelessly with the vehicle's control network over a WI-FI communications link provided by a WI-FI access point that is connected to the vehicle's control network.

Information received at the cell tower 106 is routed 108 to the Internet 110. The Internet 110 provides “access” to a computer known as a web server 112.

A personal cellular device such as a tablet, watch, phone or a connected head gear, collectively identified by reference numeral 114 and referred to herein as a mobile cellular device, carried by a taxi service requestor or subscriber, communicates with the same or different cell phone tower 116 in the same way the cell phone in the vehicle 102 communicates. Information from the mobile cell phone 114 to the web server 112 via a wireless communications channel 118.

Using techniques known in the art, the web server 112 and a web site it “hosts” is “configured” to “couple” the mobile cell phone 114 to the cell phone in the motor vehicle 102. The two phones thus communicate with each other wirelessly, through a wireless communications network, provided of course by a cell phone service carrier, as well as the Internet 110. Information or signals can thus be exchanged between the two cell phones. The “information” exchanged between the phones includes “commands” that are sent from the second cell phone 114, which is “remotely” located from the vehicle 102 using the services provided by a cell phone carrier and the Internet.

As used herein the term “bus” refers to a set (two or more) of electrically parallel conductors in a computer system that forms a main transmission path for devices connected to the bus.

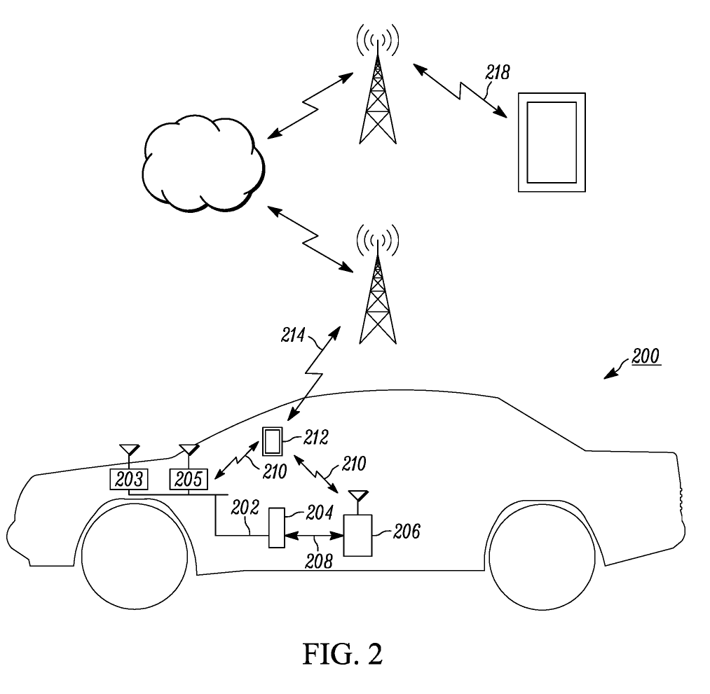

FIG. 2 is a block diagram of a motor vehicle, the annunciators of which can be controlled by a remotely-located cell phone. The vehicle 200 has a well-known controller area network or “C.A.N.” bus 202, which is a bus that allows microcontrollers and other types of devices in the vehicle to communicate with each other without requiring a host computer. The term “C.A.N. bus” should thus be construed to include any type of a bus in a motor vehicle that provides the same or essentially the same functionality.

The C.A.N. bus 202 can be accessed a number of ways. In one embodiment, the C.A.N. bus is accessed through the vehicle's on-board diagnostic or “OBD” connector 204. In another embodiment, the C.A.N. bus 202 is accessed using a WI-FI transceiver 203, built in to the vehicle 200 and connected directly to the C.A.N. bus 202. In yet another embodiment, a built-in Blue Tooth transceiver 205, directly coupled to the C.A.N. bus 202 can be “paired” with a cell phone inside the passenger compartment.

As used herein, the term “WI-FI” refers to a well-known wireless local area networking technology. Put simply, WI-FI devices are compliant with the I.E.E.E. 802.11 standards. “WI-FI” is also a trademark on the WI-FI alliance, which restricts the use of the term “WI-FI certified” to products that successfully complete interoperability certification testing.

Both the WI-FI transceiver 203 and the Blue Tooth transceiver 205 can provide a wireless communications channel 210, between each of themselves and cell phones 212 inside the vehicle 200, A wireless communications channel 210 is thus readily established between the in-vehicle cell phone 212 and the C.A.N. bus 202 using the relatively short-range wireless connectivity capabilities of a cell phone 212. Information and signals or commands 214 sent to the cell phone 212 from a cell phone network 216 thus enable remotely-originated commands 218 to be placed onto the C.A.N. bus 202.

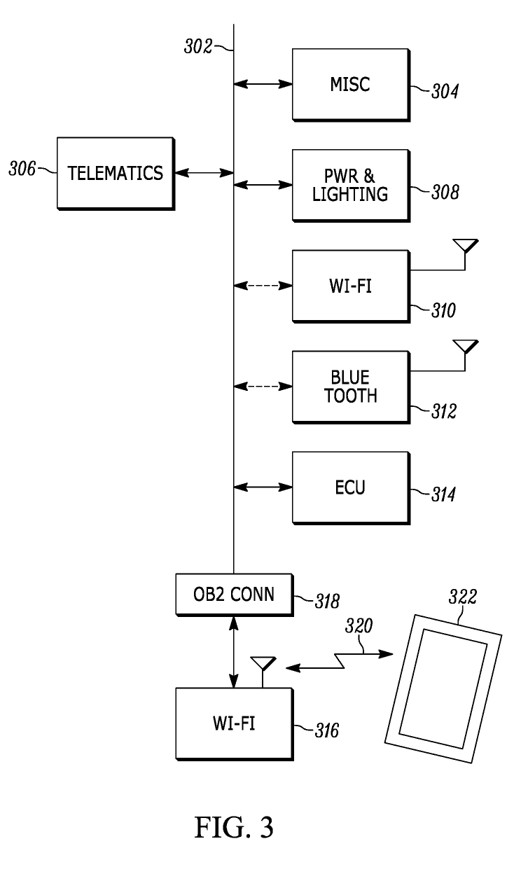

FIG. 3 is a block diagram depicting a C.A.N. bus 302 and various peripheral devices 304, 306, 308, 310, 312 and 314. In a first embodiment an “external” or “add-on” WI-FI transceiver or Blue Tooth transceiver 316 is optionally connected to an OBD connector 318 as needed. Wireless signals 320 exchanged between the transceiver 316 and a cell phone 322 thus enable the cell phone 322 to provide signals onto the C.A.N. bus 302.

In a second embodiment, a WI-FI transceiver 310 that is “internal to” or “built into” the vehicle when the vehicle is manufactured is directly connected to the C.A.N. bus 302. Wireless signals 320 exchanged between the WI-FI transceiver 316 and a cell phone 322 thus enable the cell phone 322 to provide signals onto the C.A.N. bus 302.

In a third embodiment, a Blue Tooth transceiver 312, also internal to or built into the vehicle, is directly connected to the C.A.N. bus 302. Wireless signals 320 exchanged between the Blue Tooth transceiver 312 and a cell phone 322 thus enable the cell phone 322 to provide signals onto the C.A.N. bus 302.

Information or other signals 320 provided to either the external WI-FI transceiver 316, an WI-FI internal transceiver 310 or an internal Blue Tooth transceiver 312 can be used to direct or control operation of vehicle systems and devices connected to the C.A.N. bus directly or indirectly. Examples of such systems and devices include but are not limited to a vehicle power and lighting controller 308, a vehicle telematics system 312, an engine control unit or ECU 314 or other equipment.

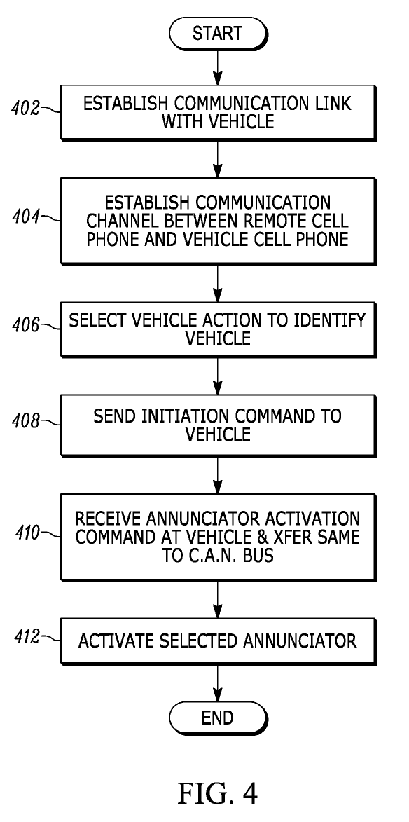

FIG. 4 depicts steps of a method for controlling a motor vehicle annunciator from a remote cell phone.

In a first step 402, a wireless communications channel is established between a cell phone inside the motor vehicle and a WI-FI transceiver, also located inside the motor vehicle but which is plugged into the OBD connector and thus has access to the vehicle's C.A.N. network.

At a second step 404, a communications channel is established between the cell phone in the vehicle and a second cell phone located outside and away from the motor vehicle. Such a wireless communications channel can be established at least two different ways. In a first and preferred method, both cell phones access a website using browsers built into the cell phones. Voice commands or icons on a personal cellular device can be used to send commands to a vehicle's C.A.N, bus and remotely control various vehicle devices and systems.

Regardless of how the two cell phones are coupled to each other, after the second communications channel between them is established, in the third step 406, a user of the taxi service at the second, remote cell phone selects a particular motor vehicle annunciator to actuate and thus differentiate the summoned vehicle from others. Such a selection is made using a menu-driven user interface with icons that identify vehicle lights, turn signals, a horn or power window actuation on a display screen of a cell phone.

At a fourth step 408, after the annunciator selected, an annunciator actuation signal is sent from the second, remote cell phone to the cell phone in the vehicle. Upon receipt of the annunciator actuation signal, the cell phone in the vehicle, passes the annunciator actuation information through the WI-FI transceiver and onto the vehicle control network, causing the annunciator to operate.

For claim construction purposes, those of ordinary skill in the art should recognize that the method depicted in FIG. 4 is a system method, i.e. it depicts steps performed by both the cell phone in the vehicle, the WI-FI transceiver, the vehicle and the remote cell phone. The method shown in FIG. 4 thus includes the method used to control the vehicle annunciator, as “viewed” from the vehicle itself. Such a method necessarily includes establishing a communications link between the cell phone in the vehicle and the WI-FI transceiver. It also includes the reception at that cell phone of an annunciator actuation signal, generated at the distant cell phone. When the annunciator actuation signal is received by the cell phone in the vehicle, it is passed or transferred to the WI-FI transceiver and from there onto the vehicle's C.A.N. bus.

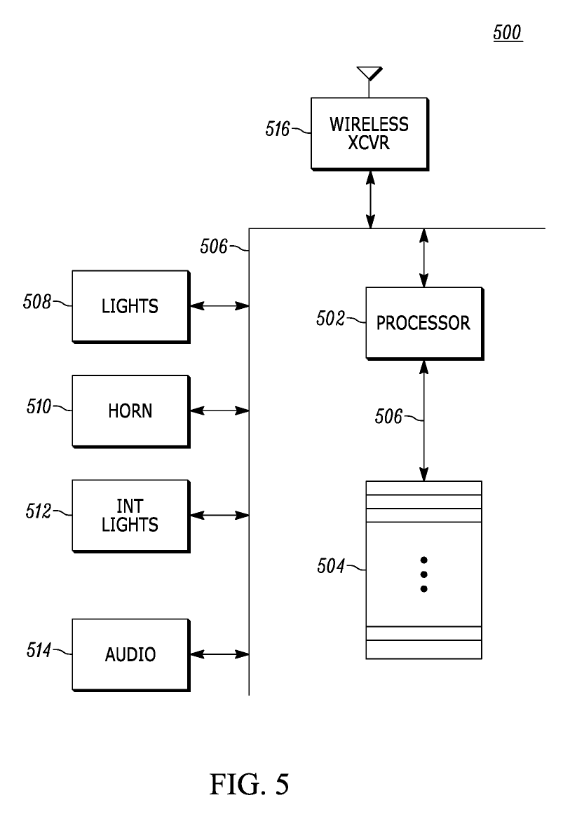

FIG. 5 is a block diagram of an apparatus for controlling a motor vehicle annunciator remotely. The apparatus 500 includes a processor 502 coupled to a non-transitory memory device 504 through a conventional address/data/control bus 506. The processor 502 is also coupled to a control bus 506 for the vehicle.

Instructions stored in the memory device 504 cause the controller 502 to perform various operations when those instructions are executed by the processor 502. More particularly, program instructions stored in the memory device 504 cause the processor 502 to perform steps shown in FIG. 4. When executed, they cause the processor 502 to assert control over a C.A.N. bus 506 through which various peripheral devices 508, 510, 512 and 514 are controlled. Other instructions cause the processor 502 to communicate with a transceiver 516 which is also coupled to the C.A.N. bus 506.

Those of ordinary skill in the art should recognize that the method and apparatus disclosed herein enables a user who summons a car for hire to control a light or lights on the vehicle in such a way that the user can identify which car he or she has arranged. The method and apparatus thus reduces the likelihood that an unsuspecting user of such a service would find himself or herself accosted or worse by mistakenly entering a vehicle similar to or resembling one which was supposed to pick the user up.

In an alternate embodiment, the driver of a vehicle for hire can also be sent a photograph image or other information of the requesting subscriber so that the driver of the vehicle can also reduce his or her exposure to physical injury.

The foregoing description is for purposes of illustration only. The true scope of the invention is set forth in the following claims.

1. A method of controlling a motor vehicle annunciator, from a cell phone located away from the motor vehicle, the method comprising:
establishing a first wireless communications channel between a first mobile cell phone located inside the motor vehicle and a second wireless transceiver located inside the motor vehicle, the second wireless transceiver being coupled to a control network for the vehicle;
establishing a second wireless communications channel between the first cell phone and a second cell phone located outside and away from the motor vehicle;
selecting, at the second cell phone, at least one of a plurality of motor vehicle annunciators to actuate;
wirelessly transmitting an annunciator actuation signal from the second cell phone to the first cell phone, the annunciator actuation signal being received by the second cell phone and passing through the wireless transceiver and onto the vehicle's control network, and
transmitting a photograph image of a requesting subscriber to a driver of the motor vehicle.

2. The method of claim 1, wherein the step of wirelessly transmitting an annunciator actuation signal from the second cell phone to the first cell phone comprises: transmitting the annunciator actuation signal through a wireless communications network.

3. The method of claim 1, wherein the step of establishing a first wireless communications channel between a first cell phone and a second wireless transceiver located inside the motor vehicle comprises:
establishing a WI-FI connection between the first cell phone and a WI-FI transceiver connected to a vehicle C.A.N. (“Controller Area Network”) bus; and
wherein information received by the WI-FI transceiver connected to the vehicle C.A.N. bus is transmitted onto the C.A.N. bus by the WI-FI transceiver.

4. The method of claim 1, wherein the step of establishing a first wireless communications channel between a first cell phone and a second wireless transceiver located inside the motor vehicle comprises:
establishing a BLUETOOTH™ connection between the first cell phone and a BLUETOOTH™ transceiver coupled to a vehicle C.A.N. bus;
wherein information received by the BLUETOOTH™ transceiver is transmitted onto the C.A.N. bus by the BLUETOOTH™ transceiver.

5. The method of claim 1, wherein the step of selecting at the second cell phone at least one of a plurality of motor vehicle annunciators to actuate comprises: selecting at the second cell phone, a light source on the motor vehicle to control.

6. The method of claim 1, wherein the step of selecting at the second cell phone at least one of a plurality of motor vehicle annunciators to actuate comprises: selecting at the second cell phone a vehicle horn to control.

7. The method of claim 1, wherein the step of selecting at the second cell phone at least one of a plurality of motor vehicle annunciators to actuate comprises selecting a vehicle window to control.

8. A method of controlling a motor vehicle annunciator from a first cell phone located away from the motor vehicle, the motor vehicle having a second cell phone inside the vehicle, which is wirelessly coupled to the vehicle's control bus via a wireless communications channel, the first and second cell phones being wirelessly coupled to a communications network, the method comprising:
selecting, at the first cell phone, at least one of a plurality of motor vehicle annunciators to actuate;
wirelessly transmitting an annunciator actuation signal from the first cell phone to the second cell phone through the communications network, and
transmitting a photograph image of a requesting subscriber to a driver of the motor vehicle.

9. The method of claim 8, wherein the step of selecting at the first cell phone at least one of a plurality of motor vehicle annunciators to actuate comprises: selecting a light source on the motor vehicle to control.

10. The method of claim 8, wherein the step of selecting at the first cell phone at least one of a plurality of motor vehicle annunciators to actuate comprises selecting a vehicle horn to control.

11. The method of claim 8, wherein the step of selecting at the first cell phone at least one of a plurality of motor vehicle annunciators to actuate comprises selecting a vehicle window to control.

12. A method of controlling a motor vehicle annunciator, the method comprising:
establishing a first wireless communications channel between a first cell phone inside the motor vehicle and a wireless transceiver located inside the motor vehicle and which is connected to a vehicle control network that is also in the motor vehicle;
receiving at the first cell phone, an annunciator actuation signal;
providing the annunciator actuation signal to the vehicle control network via the wireless transceiver; and
actuating a vehicle annunciator responsive to the step of providing the annunciator actuation signal to the vehicle control network, and
receiving a photograph image of a requesting subscriber for a driver of the motor vehicle.

13. The method of claim 12, wherein the step of actuating a vehicle annunciator comprises:
actuating a vehicle light source.

14. The method of claim 12, wherein the step of actuating a vehicle annunciator comprises:
actuating a vehicle sound device.

15. An apparatus to control a motor vehicle annunciator, from a cell phone located away from the motor vehicle, the apparatus comprising:
a wireless transceiver inside the vehicle and which is connected to a control network for the vehicle;
a processor coupled to the wireless transceiver and to the control network;
a non-transitory memory device coupled to the processor and storing executable instructions for the processor which when executed cause the processor to:
control the wireless transceiver to establish a wireless communications channel between it and a first cell phone inside the motor vehicle, the first cell phone configured to receive a photograph image of a requesting subscriber to a driver for the motor vehicle;
control the wireless transceiver to receive an annunciator actuation signal from the first cell phone; and
provide the annunciator actuation signal to the control network for the vehicle.
